(19) United States
(12) Patent Application Publication
(10) Pub. No.: US 2016/0369135 A1
(43) Pub. Date: Dec. 22, 2016

(54) ADHESIVE COMPOSITION

(71) Applicant: DONGWOO FINE-CHEM CO., LTD., Jeollabuk-do (KR)

(72) Inventors: Han Young CHOI, Gyeonggi-do (KR); Myung Young AN, Incheon (KR); Min Keun YOO, Seoul (KR)

(21) Appl. No.: 15/254,078

(22) Filed: Sep. 1, 2016

Related U.S. Application Data
(63) Continuation of application No. PCT/KR2015/002806, filed on Mar. 23, 2015.

(30) Foreign Application Priority Data
Apr. 23, 2014 (KR) 10-2014-0048859

(51) Int. Cl. C09J 133/06; C09J 7/02; C08F 120/16

(52) U.S. Cl. CPC C09J 133/06; C08F 120/16; C09J 7/026; C08F 2500/03; C09J 2203/318; C08F 2800/20; C09J 2205/114; C08F 2500/17; G02F 1/133528

(57) ABSTRACT

An adhesive composition includes an acryl copolymer having a hydroxyl group and a weight average molecular weight of 800,000 to 1,500,000 g/mol; an isocyanate-based cross-linking agent, an aliphatic hydrocarbon solvent having 6 to 10 carbon atoms, and an acid additive having a molecular weight of 40 to 100 g/mol, thus low viscosity characteristics may be maintained for a long period of time, and thereby stirring and coating may be easily performed while it does not require an excess of diluted solvent.

### CROSS-REFERENCE TO RELATED APPLICATIONS

The present application is a continuation application to International Application No. PCT/KR2015/002806, with an International Filing Date of Mar. 23, 2015, which claims the benefit of Korean Patent Application No. 10-2014-0048859, filed in the Korean Intellectual Property Office on Apr. 23, 2014, the entire contents of which are incorporated herein by reference.

### BACKGROUND

1. Field of the Invention

The present invention relates to an adhesive composition.

2. Description of the Related Art

A liquid crystal display device includes liquid crystal cells containing liquid crystals and a polarizing plate, and the liquid crystal cells and the polarizing plate are mostly bonded to each other by an adhesive layer formed on one surface of the polarizing plate. Other than the above components, in order to improve performance of the liquid crystal display device, surface protective films such as a phase retardation plate, a wide viewing angle compensation plate, a luminance-enhancing film, or the like is additionally attached to the polarizing plate by an adhesive to be used.

The adhesive used for bonding the liquid crystal cells to the polarizing plate may be exposed to hot and humid environments during manufacturing, transporting or management after the bonding, therefore, it is required that the adhesive has excellent durability in order to maintain desired adhesiveness even under the above-described severe circumstance.

In consideration of beneficial features such as weather-proof property or transparency, acryl adhesive is generally used. When an adhesive layer is formed using the acryl adhesive, high molecular weight polymer is typically used.

However, such high molecular weight polymer have drawbacks such as a high viscosity to cause a difficulty in stirring, and due to a difficulty in moving it to a container for delivery, mixing with a diluted solvent in an excess amount is required.

Further, even if the above polymer is diluted enough to move it to the container, it still has a high viscosity. Therefore, in order to use it in a coating process, a further excess of diluted solvent must be added. For these reasons, there is a problem of consuming a great amount of diluted solvent to decrease the viscosity. Accordingly, it is necessary for the adhesive composition to have low viscosity characteristics.

Furthermore, the adhesive composition may be retained as it is for a predetermined period of time depending on a production plan, while cross-linking sometimes occurs during this period. If the cross-linking proceeds in the adhesive composition as it is, a viscosity of the composition may be increased. Accordingly, it is also necessary for the adhesive composition to have viscosity stability over time.

However, such an adhesive composition that satisfies excellent durability and low viscosity characteristics simultaneously, or exhibits excellent viscosity stability while satisfying the above two characteristics, has not yet been established.

Korean Patent Laid-Open Publication No. 2011-0103321 discloses an adhesive composition, an adhesive and an adhesive sheet. However, solutions for solving these problems have not yet been established.

### SUMMARY

Accordingly, it is an aspect of the present invention to provide an adhesive composition having low viscosity characteristics.

Another aspect of the present invention is to provide an adhesive composition which has excellent viscosity stability over time so as to maintain low viscosity characteristics for a long time.

Another aspect of the present invention is to provide an adhesive composition having excellent adhesive durability.

The above aspects of the present invention will be achieved by the following characteristics:

(1) An adhesive composition including: an acryl copolymer having a hydroxyl group and a weight average molecular weight of 800,000 to 1,500,000 g/mol; an isocyanate-based cross-linking agent; an aliphatic hydrocarbon solvent having 6 to 10 carbon atoms; and an acid additive having a molecular weight of 40 to 100 g/mol.

(2) The adhesive composition according to the above (1), wherein the acryl copolymer has a weight average molecular weight of 1,000,000 to 1,400,000 g/mol.

(3) The adhesive composition according to the above (1), wherein the aliphatic hydrocarbon solvent is at least one selected from a group consisting of; 3-methylpentane, normal hexane, 2,4-dimethylpentane, 2,2,3-trimethylbutane, 3,3-dimethylpentane, 2-methylhexane, 2,3-dimethylpentane, 3-methylhexane, normal heptane, cyclohexane, methyl cyclohexane, 2,2-dimethylhexane, 2,3-dimethylhexane, 2,5-dimethylhexane, 2,4-dimethylhexane, 3,3-dimethylhexane, 3,4-dimethylhexane, 2,3,4-trimethylpentane, 2,3,3-trimethylpentane, 2-methyl-3-ethylpentane, 2-methylheptane, 3-methylheptane, 4-methylheptane, 2,2,5-trimethylhexane, normal octane, cyclooctane, nonane, cyclononane, hexane, heptene, octene and nonene.

(4) The adhesive composition according to the above (1), further including at least one solvent selected from a group consisting of an aromatic hydrocarbon solvent having 6 to 18 carbon atoms, an aliphatic carboxylic acid ester solvent having 4 to 20 carbon atoms and a ketone solvent.

(5) The adhesive composition according to the above (4), wherein the aliphatic hydrocarbon solvent is included in an amount of 20 to 80 wt. % to a total weight of the solvent.

(6) The adhesive composition according to the above (1), wherein the acid additive is at least one selected from a group consisting of acrylic acid, methacrylic acid, acetic acid, propionic acid, butanoic acid, formic acid, glycolic acid and lactic acid.

(7) The adhesive composition according to the above (1), wherein the acid additive is included in an amount of 0.5 to 5 wt. parts to 100 wt. parts of the copolymer in terms of solid content.

(8) An adhesive sheet including an adhesive layer formed of the adhesive composition according to any one of the above (1) to (7).

(9) A polarizing plate including an adhesive layer formed of the adhesive composition according to any one of the above (1) to (7) on at least one surface of the polarizing plate.

(10) An image display device including the polarizing plate according to the above (9).

The adhesive composition of the present invention has low viscosity characteristics, thereby stirring and coating may be easily performed while it does not require an excess of diluted solvent.

Further, the adhesive composition of the present invention has excellent viscosity stability over time, thus maintaining low viscosity characteristics for a long period of time.

Further, the adhesive composition of the present invention has excellent adhesive durability, therefore, even when it is exposed under high temperature and humidity environments, an occurrence of bubbles or exfoliation may be minimized.

### DETAILED DESCRIPTION

The present invention discloses an adhesive composition including: an acryl copolymer having a hydroxyl group and a weight average molecular weight of 800,000 to 1,500,000 g/mol; an isocyanate-based cross-linking agent; an aliphatic hydrocarbon solvent having 6 to 10 carbon atoms; and an acid additive having a molecular weight of 40 to 100 g/mol, thus low viscosity characteristics may be maintained for a long period of time, and thereby stirring and coating may be easily performed while it does not require an excess of diluted solvent.

Hereinafter, the present invention will be described in more details.

<Adhesive Composition>

The adhesive composition of the present invention includes an acryl copolymer.

The acryl copolymer has a hydroxyl group. Since it has the hydroxyl group, the acryl copolymer may exhibit favorable reactivity with an isocyanate cross-linking agent and be combined with the cross-linking agent to improve durability. Also, the acryl copolymer may react with an intermediate product generated during a reaction between the isocyanate cross-linking agent and an acid additive, which will be described in detail below.

The acryl copolymer is not particularly limited but may include any one generally known in the related art. For example, the acryl copolymer of the present invention may include a compound polymerized while including (meth)acrylate monomer containing an alkyl group with 1 to 12 carbon atoms and a polymerizable monomer having a cross-linkable functional group. Herein, (meth)acrylate means both of acrylate and methacrylate.

The (meth)acrylate monomer having an alkyl group with 1 to 12 carbon atoms may include, for example, n-butyl(meth)acrylate, 2-butyl(meth)acrylate, t-butyl(meth)acrylate, 2-ethylhexyl(meth)acrylate, ethyl(meth)acrylate, methyl(meth)acrylate, n-propyl(meth)acrylate, isopropyl(meth)acrylate, pentyl(meth)acrylate, n-octyl(meth)acrylate, isooctyl(meth)acrylate, nonyl(meth)acrylate, decyl(meth)acrylate, lauryl(meth)acrylate, or the like. Among these, n-butylacrylate, 2-ethylhexylacrylate or a mixture thereof is preferably used. These compound may be used alone or in combination of two or more thereof.

The (meth)acrylate monomer having an alkyl group with 1 to 12 carbon atoms may be included in an amount of 80 to 99 wt. %, and preferably, 90 to 99 wt. % to a total weight of monomers used for preparation of the acryl copolymer. If a content thereof is less than 80 wt. %, adhesiveness is not sufficient. When the content thereof exceeds 99 wt. %, cohesiveness may be reduced.

The polymerizable monomer having a functional group able to cross-link with the (meth)acrylate monomer having an alkyl group with 1 to 12 carbon atoms is a component of reinforcing cohesiveness or adhesive strength of the adhesive composition through a chemical bond to thus provide durability and cutting ability, and the acryl copolymer according to the present invention may include a monomer having a hydroxyl group.

The monomer having a hydroxyl group may include, for example, 2-hydroxyethyl (meth)acrylate, 2-hydroxypropyl (meth)acrylate, 2-hydroxybutyl (meth)acrylate, 4-hydroxyhexyl (meth)acrylate, 6-hydroxyhexyl (meth)acrylate, 2-hydroxyethyleneglycol (meth)acrylate, 2-hydroxypropyleneglycol (meth)acrylate, hydroxyalkyleneglycol (meth)acrylate having an alkylene group with 2 to 4 carbon atoms, 4-hydroxybutylvinylether, 5-hydroxypentylvinylether, 6-hydroxyhexylvinylether, 7-hydroxyheptylvinylether, 8-hydroxyoctylvinylether, 9-hydroxynonylvinylether, 10-hydroxydecylvinylether, (meth)hydroxyl alkylacrylate having a cycloalkyl group with 6 to 20 carbon atoms such as

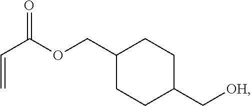

hydroxyl alkyl(meth)acrylate such as

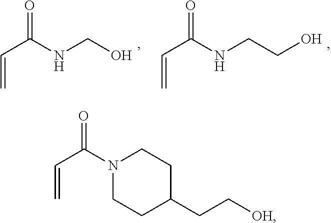

styrene derivative containing a hydroxyl group such as

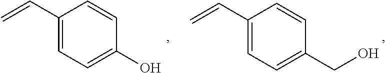

or the like. Among these, 4-hydroxybutylvinyl ether is preferably used.

The monomer having a hydroxyl group, as a cross-linkable monomer, may be included in an amount of 0.1 to 10 wt. %, and preferably, 1 to 5 wt. % to a total weight of monomers used for preparation of the acryl copolymer. If a content thereof is less than 0.1 wt. %, cohesiveness of the adhesive may be reduced to deteriorate the durability. When the content thereof exceeds 10 wt. %, adhesiveness is reduced to possibly cause a fault in exfoliation.

Other than the above components, the acryl copolymer may further include any conventionally known monomer. Such a monomer may include, for example, a monomer having a carboxyl group, a monomer having an amide group, a monomer having a tertiary amine group, or the like, which may be used alone or in combination of two or more thereof.

The monomer having a carboxyl group may include, for example: mono-valent acids such as (meth)acrylic acid, crotonic acid, carboxyethyl acrylate, etc.; di-valent acids such as maleic acid, itaconic acid, fumaric acid, etc., and monoalkylesters thereof; 3-(meth)acryloylpropionic acid; a ring-opening adduct of succinic anhydride of 2-hydroxyalkyl (meth)acrylate having an alkyl group with 2 and 3 carbon atoms, a ring-opening adduct of succinic anhydride of hydroxylalkyleneglycol (meth)acrylate having an alkylene group with 2 to 4 carbon atoms, a compound prepared by ring-opening addition of succinic anhydride to a caprolactone adduct of 2-hydroxyalkyl (meth)acrylate having an alkyl group with 2 or 3 carbon atoms, or the like. In terms of curing, carboxyethyl acrylate, or ring-opening adduct of succinic anhydride of 2-hydroxyalkyl (meth)acrylate is preferably used.

The monomer having an amide group may include, for example, (meth)acrylamide, N-isopropyl acrylamide, N-tert-butyl acrylamide, 3-hydroxypropyl (meth)acrylamide, 4-hydroxybutyl (meth)acrylamide, 6-hydroxyhexyl (meth)acrylamide, 8-hydroxyoctyl (meth)acrylamide, 2-hydroxyethylhexyl (meth)acrylamide, or the like. Among these, (meth)acrylamide is preferably used.

The monomer having a tertiary amine group may include, for example, N,N-(dimethylamino)ethyl (meth)acrylate, N,N-(diethylamino)ethyl (meth)acrylate, N,N-(dimethylamino)propyl (meth)acrylate, or the like.

The above-described monomers may be included within a range with no deterioration in adhesiveness, for example, in a content of 10 wt. % or less to a total weight of monomers used for preparation of the acryl copolymer.

Methods for preparation of a copolymer are not particularly limited but the copolymer may be prepared by any conventional polymerization method such as bulk polymerization, solution polymerization, emulsion polymerization or suspension polymerization. Solution polymerization is preferably used. Further, solvents, polymerization initiators, chain transfer agents for controlling a molecular weight, or the like, generally used in the polymerization, may also be included.

The acryl copolymer may have a weight average molecular weight (in terms of polystyrene, Mw) measured by gel permeation chromatography (GPC) of 800,000 g/mol to 1,500,000 g/mol. If the weight average molecular weight is less than 800,000 g/mol, the durability of the adhesive composition is reduced. When the weight average molecular weight exceeds 1,500,000 g/mol, the viscosity is increased. Preferably, in an aspect of ensuring excellent durability and low viscosity characteristics, simultaneously, the weight average molecular weight preferably ranges from 1,000,000 to 1,400,000 g/mol.

The cross-linking agent is a component to strengthen cohesiveness of the adhesive, and the adhesive composition of the present invention may include an isocyanate cross-linking agent. The isocyanate cross-linking agent may be advantageously used since it has excellent reactivity with the hydroxyl group in the acryl copolymer.

The isocyanate cross-linking agent may include, for example: diisocyanate compounds such as tolylene diisocyanate, xylene diisocyanate, 2,4-diphenymethane diisocyanate, 4,4-diphenylmethane diisocyanate, hexamethylene diisocyanate, isophorone diisocyanate, tetramethylene xylene diisocyanate, naphthalene diisocyanate, etc.; an adduct obtained by reacting 1 equivalent of polyalcohol compound such as trimethylolpropane with 3 equivalents of diisocyanate compound; isocyanurate obtained by self-condensing 3 equivalents of diisocyanate compound; a burette body formed by condensing diisocyanate urea obtained from 2 equivalents of diisocynate compound among 3 equivalents thereof with the remaining 1 equivalent diisocyanate; polyfunctional isocyanate compounds having three functional groups such as triphenylmethane triisocyanate, methylenebistriisocyanate, or the like, however, it is not be particularly limited thereto.

Optionally, the adhesive composition of the present invention may further include an epoxy cross-linking agent compatible with the isocynate cross-linking agent, in order to improve cohesiveness.

The epoxy cross-linking agent may include, for example, ethyleneglycol diglycidylether, diethyleneglycol diglycidylether, polyethyleneglycol diglycidylether, propyleneglycol diglycidylether, tripropyleneglycol diglycidylether, polypropyleneglycol diglycidylether, neopentylglycol diglydicylether, 1,6-hexanediol diglycidylether, polytetramethyleneglycol diglycidylether, glycerol diglycidylether, glycerol triglycidylether, diglycerol polyglycidylether, polyglycerol polyglycideylether, resorcine diglycidylether, 2,2-dibromoneopentylglycol diglycidylether, trimethylolpropane glycidylether, pentaerythritol polyglycidylether, sorbitol polyglycidylether, adipic acid glycidylester, phthalic acid glycidylester, tris(glycidyl)isocyanurate, tris(glycidoxyethyl)isocyanurate, 1,3-bis(N,N-glycidylaminomethyl)cyclohexane, tetraglycidyl-m-xylyldiamine, or the like.

A content of the cross-linking agent may range from 0.1 to 5 wt. parts, and preferably, 0.5 to 2 wt. parts to 100 wt. parts of the copolymer. If the content thereof is less than 0.1 wt. parts, cohesiveness may be decreased due to lack of cross-linking degree to hence cause a reduction in durability such as curling, and cutting ability may be deteriorated. When the content thereof exceeds 5 wt. parts, it may cause a problem in mitigating residual stress due to excess cross-linking reaction.

The adhesive composition of the present invention may include an aliphatic hydrocarbon solvent having 5 to 10 carbon atoms.

The aliphatic hydrocarbon solvent having 6 to 10 carbon atoms may function to considerably decrease the viscosity of the adhesive composition. If the number of carbon atoms is less than 6, the solvent volatilizes to decrease a content of the solvent component, thus raising the viscosity. Therefore, the solvent cannot play a role of decreasing the viscosity. When the number of carbon atoms exceeds 10, the solvent does not evaporate but remains to cause bubbling in the evaluation of adhesive durability.

The aliphatic hydrocarbon solvent having 6 to 10 carbon atoms is not particularly limited but may include, for example: aliphatic alkanes such as 3-methylpentane, normal hexane, 2,4-dimethylpentane, 2,2,3-trimethylbutane, 3,3-dimethylpentane, 2-methylhexane, 2,3-dimethylpentane, 3-methylhexane, normal heptane, cyclohexane, methyl cyclohexane, 2,2-dimethylhexane, 2,3-dimethylhexane, 2,5-dimethylhexane, 2,4-dimethylhexane, 3,3-dimethylhexane, 3,4-dimethylhexane, 2,3,4-trimethylpentane, 2,3,3-trimethylpentane, 2-methyl-3-ethylpentane, 2-methylheptane, 3-methylheptane, 4-methylheptane, 2,2,5-trimethylhexane, normal octane, cyclooctane, nonane, cyclononane, etc.; aliphatic alkenes such as hexene, heptene, octene, nonene, etc., or the like, which are used alone or in combination of two or more thereof.

The adhesive composition of the present invention may include an organic solvent conventionally used in the related art, which can be compatibly used with the aliphatic hydrocarbon solvent having 6 to 10 carbon atoms. In this case, excellent solubility in the acryl copolymer may be achieved and the viscosity stability over time may also be improved to maintain the low viscosity characteristics for a long time, thereby being preferable.

Such organic solvent may include, for example: an aromatic hydrocarbon solvent having 6 to 18 carbon atoms such as toluene, xylene, etc.; an aliphatic carboxylic acid ester solvent having 4 to 20 carbon atoms such as ethyl acetate, butyl acetate, etc.; a ketone solvent such as methylethylketone, ethylbutylketone, etc. These solvents may be used alone or in combination of two or more thereof.

The aliphatic hydrocarbon solvent having 6 to 10 carbon atoms may be included in a content of 20 to 80 wt. % to a total weight of the solvent. If the content thereof is less than 20 wt. %, effects of decreasing the viscosity may be insignificant. When the content thereof exceeds 80 wt. %, the acryl copolymer is not sufficiently dissolved to derive agglomeration of polymer, hence causing a reduction in yield due to non-uniform coating during coating.

The adhesive composition of the present invention may include an acid additive having a molecular weight of 40 to 100 g/mol.

The acid additive may further improve the viscosity stability of the adhesive composition over time. As a result, the reduced viscosity due to the added copolymer and solvent may be maintained for a long time.

The reason of the above fact is considered that the acid additive is coupled with an isocyanate group of the cross-linking agent to become a derivative in the form of a stable intermediate product, thereby inhibiting a combination of the acryl copolymer and the cross-linking agent. In addition, as the solvent is evaporated in a further drying process, the hydroxyl group in the acryl copolymer reacts with the intermediate product again to detach the acid additive from the cross-linking agent, thus proceeding gelation.

The acid additive has a molecular weight of 40 to 100 g/mol. If the molecular weight is within the above range, the acid additive is evaporated together with the solvent during drying. When the molecular weight exceeds 100 g/mol, the acid additive is not evaporated during the evaporation of the solvent but remains even after drying. Therefore, it reacts with the cross-linking agent present in the composition to decrease a gelation rate, hence reducing cohesiveness. Due to this result, bubbling occurs in the evaluation of durability.

The acid additive is not particularly limited so long as it has a molecular weight within the above described range but may include, for example, acrylic acid, methacrylic acid, acetic acid, propionic acid butanoic acid, formic acid, glycolic acid, lactic acid, or the like, which may be used alone or in combination of two or more thereof.

The acid additive may be included in an amount of 0.5 to 5 wt. parts to 100 wt. parts of the copolymer in terms of solid content. If a content thereof is less than 0.5 wt. part, effects of improving the viscosity stability over time may be insignificant. When the content thereof exceeds 5 wt. parts, it may cause problems such as acid corrosion of facilities, prolonged curing time, or the like.

Optionally, the adhesive composition of the present invention may further include a silane coupling agent.

The silane coupling agent is not particularly limited but may include, for example, vinylchlorosilane, vinyltrimethoxysilane, vinyltriethoxysilane, 2-(3,4-epoxy cyclohexyl)ethyltrimethoxysilane, 3-glycidoxypropyltrimethoxysilane, 3-glycidoxypropylmethyldiethoxysilane, 3-glycidoxypropyldietoxysilane, 3-glycidoxypropyltriethoxysilane, p-styryltrimethoxysilane, 3-methacryloxypropyltriethoxysilane, 3-methacryloxypropyltrimethoxysilane, 3-methacryloxypropylmethyldimethoxysilane, 3-methacryloxypropylmethyldiethoxysilane, 3-acryloxypropyltrimethoxysilane, N-2-(aminoethyl)-3-aminopropylmethyldimethoxysilane, N-2-(aminoethyl)-3-aminopropyltrimethoxysilane, N-2-(aminoethyl)-3-aminopropylmethyltriethoxysilane, 3-aminopropyltrimethoxysilane, 3-aminopropyltriethoxysilane, 3-triethoxysilyl-N-(1,3-dimethylbutylidene)propylamine, N-phenyl-3-aminopropyltrimethoxysilane, 3-chloropropyltrimethoxysilane, 3-mercaptopropylmethyldimethoxysilane, 3-mercaptopropyltrimethoxysilane, bis(triethoxysilylpropyl)tetrasulfide, 3-isocyanatepropyltriethoxysilane, silane having a substituted acetamide group, or the like. However, in order to simultaneously satisfy desired durability and reworkability, silane is preferably used. These compounds may be used alone or in combination of two or more thereof.

A content of the silane compound be included in an amount of 0 to 10 wt. parts, and preferably, 0.005 to 5 wt. parts to 100 wt. parts of the copolymer in terms of solid content. When the content thereof exceeds 10 wt. parts, durability may be reduced.

In order to impart antistatic property, the adhesive composition of the present invention may further include an antistatic agent. For example, the antistatic agent may be selected from ionic salts, which are formed by combination of anions selected from iodine, fluorosulfonylimide (FSI) and trifluoromethylsulfonylimide (TFSI) and cations selected from Li, Na and K. In aspects of durability and antistatic property, LiI, LiTSI and/or LiTFSI are preferably used.

<Adhesive Sheet>

Further, the present invention provides an adhesive sheet including an adhesive layer formed of the adhesive composition.

A thickness of the adhesive layer is not particularly limited but may range, for example, from 0.5 to 50 μm.

The adhesive sheet of the present invention may include an adhesive layer formed on at least one surface of a release film.

The adhesive layer may be formed by coating the at least one surface of the release film with the adhesive composition. A coating method is not particularly limited but may include any conventional method known in the related art. For example, bar coater, air knife, gravure, reverse roll, kiss roll, spray, blade, die coater, casting, spin coating, or the like may be employed.

The release film is not particularly limited but may include any conventional release film used in the related art. For example, polyester resin such as polyethylene terephthalate, polybutylene terephthalate, polyethylene naphthalate, polybutylene naphthalate, etc.; polyimide resin; acryl resin; styrene resin such as polystyrene and acrylonitrile-styrene; polycarbonate resin; polylactic acid resin; polyurethane resin; polyolefin resin such as polyethylene, polypropylene, ethylene-propylene copolymer; vinyl resin such as polyvinyl chloride, polyvinylidene chloride, etc.; sulfone resin; polyether-ether ketone resin; allylate resin; or a mixture thereof may be used.

A thickness of the release film is not particularly limited but may range, for example, from 5 to 500 μm, and preferably, 10 to 100 μm.

<Polarizing Plate>

Further, the present invention provides a polarizing plate including an adhesive layer formed of the adhesive composition on at least one surface thereof.

The polarizing plate of the present invention may include a polarizer, a protective film adhered to at least one surface of the polarizer, and an adhesive layer formed of the adhesive composition on the protective film.

The polarizer may be any polarizer known in the related art, and for example, prepared by a process such as swelling, dying, cross-linking, drawing, washing, drying a polyvinyl alcohol film, or the like.

The protective film used herein may be any film so far as the film has excellent properties such as transparency, mechanical strength, thermal stability, moisture-shielding properties, isotropic properties, or the like. In particular, polyester films such as polyethylene terephthalate, polyethylene isophthalate, polybutylene terephthalate, etc.; cellulose films such as diacetylocellulose, triacetylcellulose, etc.; polycarbonate films; acryl films such as polymethyl (meth)acrylate, polyethyl (meth)acrylate, etc.; styrene films such as polystyrene, acrylonitrile-styrene copolymer, etc.; polyolefin films; vinyl chloride films; polyamide films such as nylon, aromatic polyamide, etc.; imide films; sulfone films; polyetherketone films; polyphenylene sulfide films; vinyl alcohol films; vinylidene chloride films; vinyl butyral films; allylate films; polyoxymethylene films; urethane films; epoxy films; silicon films, or the like, may be used. In particular, the cellulose film having a surface saponified using alkali or the like is preferably used among the above compounds, in consideration of polar properties or durability. The protective film may further have the function of an optical layer.

The adhesive layer may be directly applied to the protective film, or formed by attaching an adhesive sheet to the protective film.

<Image Display Device>

Further, the present invention provides an image display device including the above-described polarizing plate.

The image display device of the present invention may further include any conventionally known configurations in addition to the above polarizing plate.

Hereinafter, preferred embodiments are proposed to more concretely describe the present invention. However, the following examples are only given for illustrating the present invention and those skilled in the art will obviously understand that these examples do not restrict the appended claims but various alterations and modifications are possible within the scope and spirit of the present invention. Such alterations and modifications are duly included in the appended claims.

### Preparative Example 1

### Preparation of Acryl Copolymer A-1

A monomer mixture including 98 wt. parts of n-butyl acrylate (BA) and 2 wt. parts of hydroxyethyl acrylate was introduced into 1 L reactor equipped with a cooling device for easy control of temperature, in which a nitrogen gas is refluxed. Then, a solvent, that is, 90 wt. parts of ethyl acetate (EA) was added thereto. Next, after purging the nitrogen gas for 1 hour in order to remove oxygen, the mixture was maintained at 80° C. After homogenizing the monomer mixture, 0.07 wt. parts of a reaction initiator, that is, azobisisobutyronitrile (AIBN) was introduced into the reactor, followed by a reaction for 8 hours. After completing the reaction, 143 wt. parts of ethyl acetate was further added to prepare an acryl copolymer A-1 with a weight average molecular weight of about 1,000,000 and a solid content of 30%.

### Preparative Example 2

### Preparation of Acryl Copolymer A-2

An acryl copolymer A-2 with a weight average molecular weight of 800,000 and a solid content of 30% was prepared according to the same procedures as described in Preparative Example 1, except that the synthetic solvent, that is, ethyl acetate (EA) was used in an amount of not 90 wt. parts but 100 wt. parts and, after completing the reaction, 133 wt. parts of ethyl acetate was added.

### Preparative Example 3

### Preparation of Acryl Copolymer A-3

An acryl copolymer A-3 with a weight average molecular weight of 1,500,000 and a solid content of 30% was prepared according to the same procedures as described in Preparative Example 1, except that the synthetic solvent, that is, ethyl acetate (EA) was used in an amount of not 90 wt. parts but 75 wt. parts and, after completing the reaction, 158 wt. parts of ethyl acetate was added.

### Preparative Example 4

### Preparation of Acryl Copolymer A-4

An acryl copolymer A-4 with a weight average molecular weight of 1,600,000 and a solid content of 30% was prepared according to the same procedures as described in Preparative Example 1, except that the synthetic solvent, that is, ethyl acetate (EA) was used in an amount of not 90 wt. parts but 70 wt. parts and, after completing the reaction, 163 wt. parts of ethyl acetate was added.

### EXAMPLES AND COMPARATIVE EXAMPLES

### (1) Adhesive Composition

Adhesive compositions having constitutional compositions and contents (wt. parts) listed in Table 1 below were prepared.

TABLE 1

| | | Cross- | | | | Silane |
|---|---|---|---|---|---|---|
| | Acryl | linking | | | Acid | coupling |
| Section | copolymer | agent | Solvent | | additive | agent |
| Example 1 | Preparative | Coronate-L | MEK | Hexane | Acetic | KBM403 |
| | Example 1 | (0.5) | (50) | (50) | acid (1) | (0.5) |
| | (100) | | | | | |
| Example 2 | Preparative | Coronate-L | MEK | Hexane | Acetic | KBM403 |
| | Example 2 | (0.5) | (50) | (50) | acid (1) | (0.5) |
| | (100) | | | | | |
| Example 3 | Preparative | Coronate-L | MEK | Hexane | Acetic | KBM403 |
| | Example 3 | (0.5) | (50) | (50) | acid (1) | (0.5) |
| | (100) | | | | | |
| Example 4 | Preparative | Coronate-L | MEK | Heptane | Acetic | KBM403 |
| | Example 1 | (0.5) | (50) | (50) | acid (1) | (0.5) |
| | (100) | | | | | |
| Example 5 | Preparative | Coronate-L | MEK | Hexane | Acetic | KBM403 |
| | Example 1 | (0.5) | (50) | (50) | acid (1) | (0.5) |
| | (100) | | | | | |
| Example 6 | Preparative | Coronate-L | MEK | hexane | Acrylic | KBM403 |
| | Example 1 | (0.5) | (50) | (50) | acid (1) | (0.5) |
| | (100) | | | | | |
| Example 7 | Preparative | Coronate-L | MEK | Hexane | Acetic | KBM403 |
| | Example 1 | (0.5) | (70) | (20) | acid (1) | (0.5) |
| | (100) | | | | | |
| Example 8 | Preparative | Coronate-L | MEK | Hexane | Acetic | KBM403 |
| | Example 1 | (0.5) | (20) | (80) | acid (1) | (0.5) |
| | (100) | | | | | |
| Example 9 | Preparative | Coronate-L | MEK | Hexane | Acetic | KBM403 |
| | Example 1 | (0.5) | (83) | (17) | acid (1) | (0.5) |
| | (100) | | | | | |
| Example | Preparative | Coronate-L | MEK | Hexane | Acetic | KBM403 |
| 10 | Example 1 | (0.5) | (15) | (85) | acid (1) | (0.5) |
| | (100) | | | | | |
| Comparative | Preparative | Coronate-L | MEK | — | Acetic | KBM403 |
| Example 1 | Example 1 | (0.5) | (100) | | acid (1) | (0.5) |
| | (100) | | | | | |
| Comparative | Preparative | Coronate-L | MEK | Hexane | — | KBM403 |
| Example 2 | Example 1 | (0.5) | (50) | (50) | | (0.5) |
| | (100) | | | | | |
| Comparative | Preparative | Coronate-L | MEK | Hexane | Acetic | KBM403 |
| Example 3 | Example 4 | (0.5) | (50) | (50) | acid (1) | (0.5) |
| | (100) | | | | | |
| Comparative | Preparative | Coronate-L | MEK | Pentane | Acetic | KBM403 |
| Example 4 | Example 1 | (0.5) | (50) | (50) | acid (1) | (0.5) |
| | (100) | | | | | |
| Comparative | Preparative | Coronate-L | MEK | Undecane | Acetic | KBM403 |
| Example 5 | Example 1 | (0.5) | (50) | (50) | acid (1) | (0.5) |
| | (100) | | | | | |
| Comparative | Preparative | Coronate-L | MEK | Hexane | Pentanoic | KBM403 |
| Example 6 | Example 1 | (0.5) | (50) | (50) | acid | (0.5) |
| | (100) | | | | (1) | |

MEK: methylethylketone

### (2) Adhesive Sheet

Each of the prepared adhesive compositions was applied to a film coated with a silicon release agent, followed by drying at 100° C. for 1 minute to form an adhesive layer having a thickness of 25 μm. Then, another layer of release film was laminated on the above adhesive layer to produce an adhesive sheet.

### (3) Adhesive-Adhered Polarizing Plate

After peeling-off the release film from the produced adhesive sheet, the adhesive layer was laminated on an iodine-based polarizing plate having a thickness of 185 μm by a bonding process to thus fabricate a polarizing plate including the adhesive adhered thereto

### Experimental Example

Physical properties of the adhesive compositions, the adhesive sheets and the adhesive-adhered polarizing plates prepared in the examples and comparative examples were measured according to the following procedures, and results thereof are shown in Table 2 below.

### (1) Viscosity Characteristic and Variation in Viscosity Over Time

With regard to each of the adhesive compositions prepared in the examples and comparative examples, initial viscosity and viscosity after leaving the same at room temperature for 24 hours were measured. In this regard, a viscometer (Brookfield LVDV-II+B type viscometer (spindle no. 2, 30 rpm)) was used. Measured results are shown in Table 2 according to the following standards for evaluation.

### (2) Durability (Heat Resistance, Heat and Humidity Resistance)

After cutting the adhesive-adhered polarizing plate into a size of 90 mm×170 mm and peeling-off the release film from the same, the cut plate was attached to both sides of a glass substrate (110 mm×190 mm×0.7 mm) such that optical absorption axes thereof are perpendicular to each other to fabricate a specimen. In this regard, a pressure applied thereto was 5 kg/cm², and the working was conducted in a clean-room. Heat resistance was determined by leaving the specimen at 80° C. for 1000 hours, and then an occurrence of bubbling or exfoliation was observed. Likewise, heat and humidity resistance was determined by leaving the specimen at 60° C. under a condition of 90% RH for 1000 hours, then, an occurrence of bubbling or exfoliation was observed. Herein, evaluation by observing was performed after leaving the specimen at room temperature for 24 hours just before evaluating.

<Standards for Evaluation>

TABLE 2

| | Initial | Viscosity | | Heat and |
|---|---|---|---|---|
| | viscosity | over time | Heat | humidity |
| Section | (cP) | (cP) | resistance | resistance |
| Example 1 | 560 | 630 | ⊚ | ⊚ |
| Example 2 | 430 | 480 | ◯ | ⊚ |
| Example 3 | 910 | 980 | ⊚ | ⊚ |
| Example 4 | 530 | 600 | ⊚ | ⊚ |
| Example 5 | 580 | 640 | ⊚ | ⊚ |
| Example 6 | 580 | 720 | ⊚ | ⊚ |
| Example 7 | 640 | 710 | ⊚ | ⊚ |
| Example 8 | 420 | 590 | ⊚ | ⊚ |
| Example 9 | 720 | 760 | ⊚ | ⊚ |
| Example 10 | 380 | 580 | ⊚ | ⊚ |
| Comparative | 870 | 910 | ⊚ | ⊚ |
| Example 1 | | | | |
| Comparative | 545 | 1350 | ⊚ | ⊚ |
| Example 2 | | | | |
| Comparative | 1080 | 1150 | ⊚ | ⊚ |
| Example 3 | | | | |
| Comparative | 540 | 980 | ⊚ | ⊚ |
| Example 4 | | | | |
| Comparative | 610 | 670 | X | Δ |
| Example 5 | | | | |
| Comparative | 560 | 690 | Δ | Δ |
| Example 6 | | | | |

⊚: no bubble or exfoliation
◯: number of bubbles or exfoliation < 5
Δ: 5 ≦ number of bubbles or exfoliations < 10
x: 10 ≦ number of bubbles or exfoliations

Referring to Table 2, it can be seen that each of the adhesive compositions prepared in Examples 1 to 10 has a low viscosity and, even after leaving the same for 24 hours, the viscosity was not greatly increased, thereby exhibiting excellent viscosity stability over time. Further, it also achieved excellent heat resistance, as well as heat and humidity resistance.

More particularly, it was found that each of the compositions in Examples 1 to 3 involved an increase in initial viscosity along an increase in molecular weight of the acryl copolymer. For Example 3 including the acryl copolymer with a molecular weight of 1,500,000, the composition had a low initial viscosity of about 1000 cP or less.

Meanwhile, Examples 4 to 6 have adopted an aliphatic hydrocarbon solvent or acid additive different from those used in Examples 1 to 3, while Examples 7 to 10 have altered a content of the aliphatic hydrocarbon solvent to different values. Nevertheless, these examples still demonstrated excellent effects.

However, the compositions prepared in Comparative Examples 1 to 6 involved relatively high viscosity or, after leaving those for 24 hours, the viscosity was considerably increased. Further, durability was reduced in some cases.

More particularly, Comparative Examples 1 and 2 using the same acryl copolymer as Examples 1 showed an increase in initial viscosity or a reduction in viscosity stability over time, compared to Example 1.

Alternatively, Comparative Example 3 using the same acryl copolymer as Example 3 showed a great increase in initial viscosity, compared to Example 3. As a result, the initial viscosity exceeded 1000 cP.

In the case of Comparative Examples 4 to 6 using an aliphatic hydrocarbon solvent, of which the number of carbon atoms is out of the range defined by the preset invention, otherwise, an acid additive having a high molecular weight, the viscosity stability over time was decreased, or the solvent or adhesive remained even after drying, hence durability of the adhesive was reduced.

What is claimed is:

1. An adhesive composition comprising:
an acryl copolymer having a hydroxyl group and a weight average molecular weight of 800,000 to 1,500,000 g/mol;
an isocyanate-based cross-linking agent;
an aliphatic hydrocarbon solvent having 6 to 10 carbon atoms; and
an acid additive having a molecular weight of 40 to 100 g/mol.

2. The adhesive composition according to claim 1, wherein the acryl copolymer has a weight average molecular weight of 1,000,000 to 1,400,000 g/mol.

3. The adhesive composition according to claim 1, wherein the aliphatic hydrocarbon solvent is at least one selected from the group consisting of; 3-methylpentane, normal hexane, 2,4-dimethylpentane, 2,2,3-trimethylbutane, 3,3-dimethylpentane, 2-methylhexane, 2,3-dimethylpentane, 3-methylhexane, normal heptane, cyclohexane, methyl cyclohexane, 2,2-dimethylhexane, 2,3-dimethylhexane, 2,5-dimethylhexane, 2,4-dimethylhexane, 3,3-dimethylhexane, 3,4-dimethylhexane, 2,3,4-trimethylpentane, 2,3,3-trimethylpentane, 2-methyl-3-ethylpentane, 2-methylheptane, 3-methylheptane, 4-methylheptane, 2,2,5-trimethylhexane, normal octane, cyclooctane, nonane, cyclononane, hexane, heptene, octene and nonene.

4. The adhesive composition according to claim 1, further comprising at least one solvent selected from the group consisting of an aromatic hydrocarbon solvent having 6 to 18 carbon atoms, an aliphatic carboxylic acid ester solvent having 4 to 20 carbon atoms and a ketone solvent.

5. The adhesive composition according to claim 3, wherein the aliphatic hydrocarbon solvent is included in an amount of 20 to 80 wt. % to a total weight of the solvent.

6. The adhesive composition according to claim 1, wherein the acid additive is at least one selected from the group consisting of acrylic acid, methacrylic acid, acetic acid, propionic acid, butanoic acid, formic acid, glycolic acid and lactic acid.

7. The adhesive composition according to claim 1, wherein the acid additive is included in an amount of 0.5 to 5 wt. parts to 100 wt. parts of the copolymer in terms of solid content.

8. The adhesive composition according to claim 1, further comprising a silane coupling agent.

9. An adhesive sheet comprising an adhesive layer formed of the adhesive composition according to claim 1.

10. A polarizing plate comprising an adhesive layer formed of the adhesive composition according to claim 1 on at least one surface of the polarizing plate.

11. An image display device comprising the polarizing plate according to claim 10.
